(19) United States
(12) Patent Application Publication
(10) Pub. No.: US 2008/0314328 A1
(43) Pub. Date: Dec. 25, 2008

(54) Litter box sifter-lifter

(76) Inventor: Kristy Johnson, Plano, TX (US)

Correspondence Address: JAMES RAY & ASSOCIATES, 2640 Pitcairn Road, Monroeville, PA, 15146, US

(21) Appl. No.: 11/821,341

(22) Filed: Jun. 22, 2007

(51) Int. Cl. A01K 29/00

(52) U.S. Cl. 119/166

(57) ABSTRACT

An apparatus for use with cleaning litter from a cat's litter box. The apparatus comprises a base member having a predetermined shape and formed of a predetermined material and a second member engageable with the base member. The second member has a plurality of chamfered apertures disposed in a bottom portion of the second member.

### FIELD OF THE INVENTION

The present invention relates, in general, to a cat's litter box, and, more particularly, the present invention relates to a cat litter cleaning method for removing the debris from the litter so as to be able to return the cleaned litter to the cat's box.

### BACKGROUND OF THE INVENTION

Cat litter boxes are used routinely to provide cats with easy access to a relief station. The conventional litter box consists of a rectangular box having an open top end and the litter box is filled with approximately two or three inches of a granular material that is commonly referred to as cat litter. This cat litter is discarded and replaced as it becomes soiled to a certain degree. Cat litter that is referred to as “clumpable” facilitates the cleaning and reusing of the cat litter, because the moisture is absorbed and forms clumps. These clumps along with feces are removed by lifting them out and disposing of them. The lifting is usually done with a scooper or sifter that have openings therein to permit the “clean” litter to remain in the box and the spoiled litter to remain in the sifter for discarding. This type of cleaning of the litter box leaves a great deal to be desired because the openings in the sifter are generally large enough that some soiled litter or feces is returned to the litter box. Further, this type of cleaning is not only tedious and time consuming but is also unhygenic.

Thus, it would be advantageous if there were a simpler means of cleaning the cats litter so as to leave clean litter to be returned to the box and the soiled litter easily disposed of.

### SUMMARY OF THE INVENTION

In a first aspect the present invention provides an apparatus for use with cleaning litter from a cat's litter box. The apparatus comprises a base container member having a predetermined shape and formed of a predetermined material and a second container member that is engageable with the base member. The second container member has a plurality of chamfered apertures disposed in a bottom portion of the second member.

In a second aspect the present invention provides a method for removing soiled debris from a cat's litter box. The method comprising the steps of providing a base container member and then placing a second container having a plurality of chamfered holes in a base portion of the second container member into the first container member. The next step is pouring soiled litter from a cat's litter box into the top of the second container member and allowing the clean litter to pass through the chamfered apertures into the base container member while collecting the soiled debris in the second container member. There is a step of returning the clean litter that was collected in the base container to such cat's litter box and a step of disposing of the soiled debris that was retained in the second container in an appropriate manner.

### OBJECTS OF THE INVENTION

It is, therefore, one of the primary objects of the present invention to provide an apparatus for removing the soiled litter from a cats litter box.

Another object of the present invention is to provide an apparatus in which the soiled litter is poured into the apparatus.

Still another object of the present invention is to provide an apparatus in which the clean litter passes through the apparatus to a second container while the soiled litter is retained in a first container.

Yet another object of the present invention is to provide an apparatus in which the clean litter is passed through the first container rapidly by having chamfered apertures in the sifter.

Another object of the present invention is to provide an apparatus in which the flow dynamics of the litter passing through the chamfered apertures is increased and the breaking apart of the soiled debris clumps is reduced.

Still another object of the present invention is to provide a method for removing debris from a cats litter box.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of the apparatus according to an embodiment of the invention.

FIG. 2 is a cross-sectional view of the apparatus shown in FIG. 1.

FIG. 3 is an enlarged view of the apertures shown in the previous Figures taken across the lines III-III in FIG. 2.

FIG. 4 is a cross-sectional view of the apparatus showing a preferred configuration for the base member.

FIG. 5 is a top view of the second container member showing the structural ribs, the apertures and the lip members.

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for use with cleaning the soiled litter from a cat's litter box (not shown). The apparatus 10 comprises a base member 2 having a first predetermined shape and formed of a first predetermined material and a second member 4 that is engageable with the base member 2, such second member 4 having a second predetermined shape and formed of a second predetermined material. The second member 4 has a plurality of chamfered apertures 12 disposed in a bottom portion of the second member 4.

The predetermined shape of such base member 2 can be round, oval, square or rectangular. It is presently preferred that such shape is rectangular. Further, the predetermined shape is substantially a rectangular container with an open top. It is important that the second predetermined shape of such second member 4 is similar to the first predetermined shape of the base member 2. That is, if the first predetermined shape is rectangular then the second predetermined shape must also be rectangular. Similarly, if the first predetermined shape is circular then the second predetermined shapes must also be circular.

This is important because the second member 4 fits or nests into the open top of the base member 2. The base member 2 has a lip portion 6 which extends around an outer periphery of the open top of the base member 2. The second member 4 also has a lip member 8 which extends around an outer periphery of an open top of the second member 2. The lip member 8 of the second member 4 engages the lip portion 6 of the base member. Thus, such second member 4 when it is placed in the base member is prevented from dropping to the bottom of such base member 2 and there is a space between the bottom of such second member 4 and the bottom of such base member 2.

It should be noted that the present invention, as seen in FIG. 3, provides that the plurality of apertures 12 in such second member are chamfered, that is, the apertures are beveled. The top portion of these apertures 12 are essentially cone shaped. This shape permits an increase in the flow dynamics of the cat litter passing through the apparatus 10. Further, the chamfered apertures 12 aid in minimizing the clumping cat waste debris from breaking apart, which means that more of the waste debris will be retained in the second member 2 and less of the debris will pass through the apertures 12 with the cleaned cat litter.

It should further be noted the present invention is primarily designed to be used with the type of cat litter that is referred to as “clumpable”. Clumpable cat litter facilitates the cleaning and reusing of the cat litter, because the moisture is absorbed and forms clumps. These clumps along with feces are retained in the second member while the cleaned cat litter passes through the apertures into the first container.

It is presently preferred that the predetermined diameter of the top end of the apertures, that is the top of the chamfer, is between about 0.24 and about 0.26 inches and even more preferred that the predetermined diameter is between about 0.245 and about 0.255 inches. It is also preferred if the predetermined diameter of the bottom end of the apertures is between about 0.21 and about 0.23 inches.

Thus, the present invention provides an apparatus 10 in which the cat's litter box is picked up and the litter poured into the apparatus 10. The litter passes through the apertures 12 in the bottom of the second member 4 and falls into the base member 2 while the waste debris is retained in the second member 4. The waste debris is then disposed of in an appropriate manner and the waste free litter can then be returned by pouring the now recycled and cleaned litter back into the litter box.

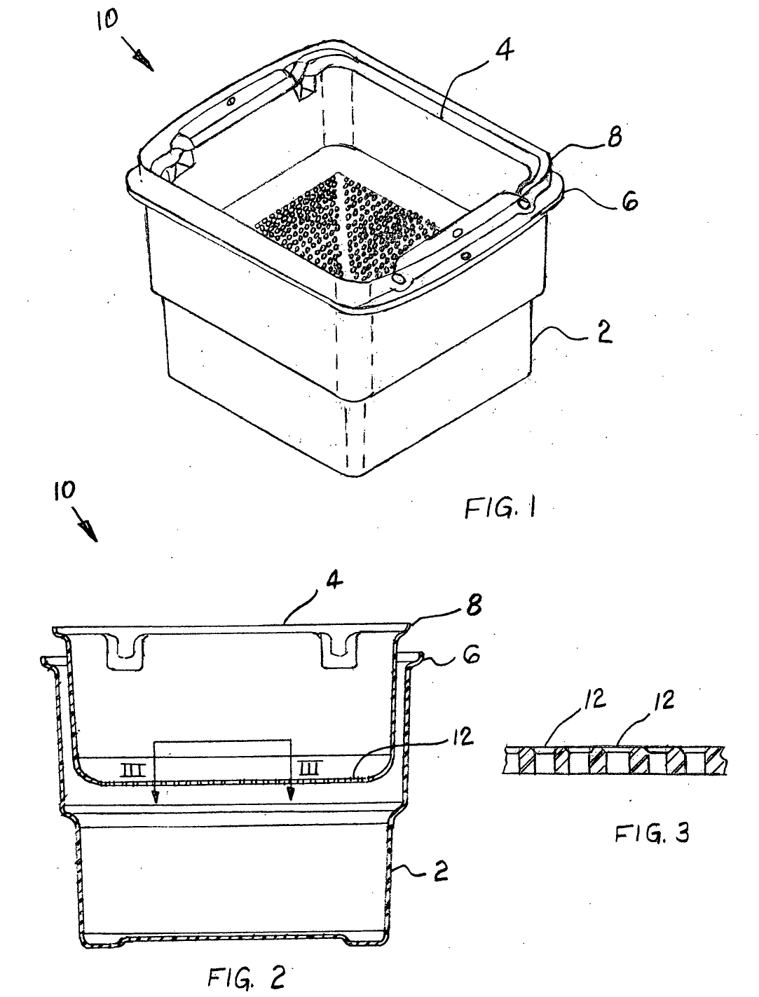

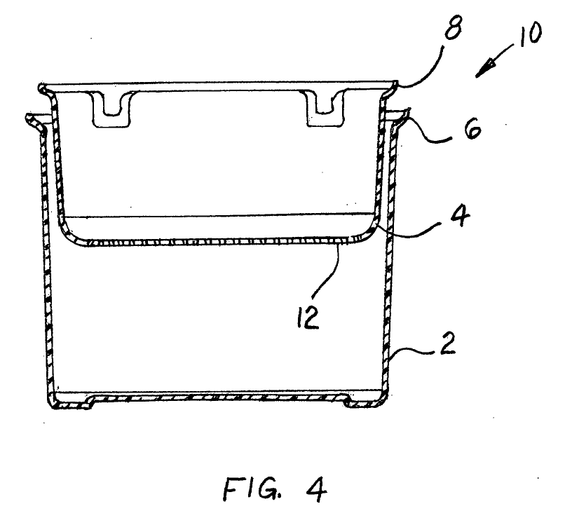

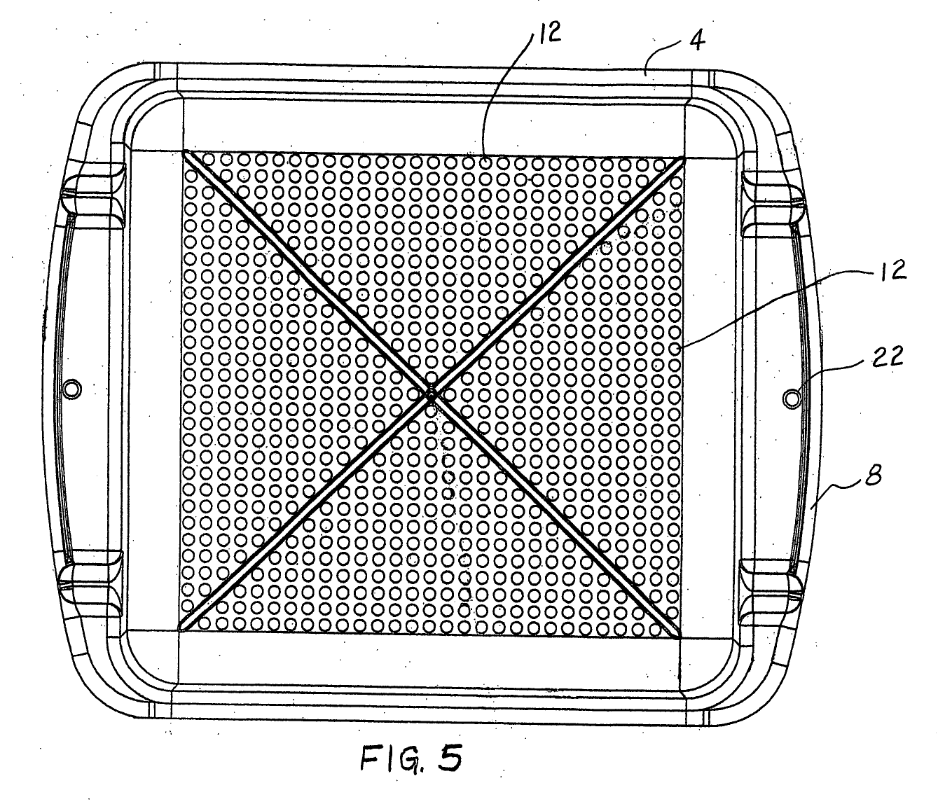

FIG. 5 shows the structural ribs and the bottom of the sifting second container member 4. Also seen is the lip portion (or handle member) 8 of the second container member 4. There are holes 22 disposed on each of the lip portions 8. Similar holes are disposed on the lip portion 6 of base container member 2. The holes are used to tie the two units together so they can be packaged as a unit. The unit that is seen in FIG. 1 has a shape such that one such unit (base member 2 and second member 4) can stack into another similar unit.

It should, further, be noted that it is within the scope of the invention that such apertures 12 be formed in the shape of a cone, that is, the apertures are beveled from the upper surface to the bottom surface.

It is presently preferred that both the first predetermined material and the second predetermined material be formed of plastic. It is also preferred that such plastic be selected from one of high impact acrylonitrile butadiene styrene or polypropylene.

In a second aspect the present invention provides a method for removing soiled debris from a cat's litter box. The method comprising the steps of providing a base container member 2 and then placing a second container member 4 having a plurality of chamfered apertures 12 disposed in a base portion of the second container member 4 into the first container member 2. The next step involves pouring soiled litter from a cat's litter box into the top of the second container member 4 and allowing the clean litter to pass through the chamfered apertures 12 into the base container member 2 while collecting the soiled debris in the second container member 4. There is a step of returning the clean litter that was collected in the base container member 2 to such cat's litter box and a step of disposing of the soiled debris that was retained in the second container member 4 in an appropriate manner.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for use with cleaning litter from a cat's litter box, said apparatus comprising:
(a) a base container member having a first predetermined shape and formed of a first predetermined material; and
(b) a second container member engageable with said base container member and having a second predetermined shape and formed of a second predetermined material, said second container member having a plurality of chamfered apertures, having a predetermined diameter adjacent each end thereof, disposed in a bottom portion of said second container member.

2. The apparatus, according to claim 1, wherein said first predetermined shape of said base container member is one of circular, oval, square and rectangular.

3. The apparatus, according to claim 2, wherein said first predetermined shape of said base member is rectangular.

4. The apparatus, according to claim 1, wherein said second predetermined shape of said second container member is substantially identical to said first predetermined shape.

5. The apparatus, according to claim 3, wherein said first predetermined shape of said base member is substantially a rectangular container having an open top.

6. The apparatus, according to claim 5, wherein said second predetermined shape is substantially a rectangular container having an open top.

7. The apparatus, according to claim 6, wherein said second predetermined shape of said second member is not as large as said first predetermined shape so that said second member can fit inside said base member.

8. The apparatus, according to claim 7, wherein said first predetermined shape further includes a lip portion that extends around an outer periphery of said open top.

9. The apparatus, according to claim 8, wherein said second predetermined shape of said second member further includes a lip member that extends around an outer periphery of said open top.

10. The apparatus, according to claim 8, wherein said lip member of said second member engages said lip portion of said base member when said second member is placed in said base member.

11. The apparatus, according to claim 1, wherein said first predetermined material is plastic.

12. The apparatus, according to claim 1, wherein said second predetermined material is plastic.

13. The apparatus, according to claim 11, wherein said plastic is selected from one of high impact acrylonitrile butadiene styrene and polypropylene.

14. The apparatus, according to claim 12, wherein said plastic is selected from one of high impact acrylonitrile butadiene styrene and polypropylene.

15. The apparatus, according to claim 1, wherein said predetermined diameter of the upper end of the apertures is between about 0.24 and about 0.26 inches.

16. The apparatus, according to claim 15, wherein said predetermined diameter of the upper end of the apertures is between about 0.245 and about 0.255 inches.

17. The apparatus, according to claim 1, wherein said predetermined diameter of the bottom end of the apertures is between about 0.21 and about 0.23 inches.

18. A method for removing debris from a cat's litter box, said method comprising the steps of:
(a) providing a base container;
(b) placing a second container having a plurality of chamfered holes in a base portion of said second container into said first container;
(c) pouring the soiled litter from a cat's litter box into the top of said second container;
(d) allowing the clean litter to pass through said chamfered apertures into said base container while collecting the soiled debris in said second container;
(e) returning said clean litter from said base container to such cat's litter box; and
(f) disposing of said soiled debris retained in said second container in an appropriate manner.
